(19) United States
(12) Patent Application Publication
(10) Pub. No.: US 2026/0202524 A1
(43) Pub. Date: Jul. 16, 2026

(54) USING VEHICLE-TO-EVERYTHING DATA IN A SAFETY SYSTEM

(71) Applicant: QUALCOMM Incorporated, San Diego, CA (US)

(72) Inventor: Onn HARAN, Even Yehuda (IL)

(21) Appl. No.: 19/448,049

(22) Filed: Jan. 13, 2026

Related U.S. Application Data
(60) Provisional application No. 63/745,329, filed on Jan. 15, 2025.

(51) Int. Cl. G01S 7/497; G01S 7/40; H04W 4/40

(52) U.S. Cl. CPC G01S 7/497; G01S 7/40; G01S 2007/4975; H04W 4/40

(57) ABSTRACT

This disclosure provides methods, components, devices and systems for using vehicle-to-everything (V2X) data in a safety system. For example, a first wireless communication device may calculate a deviation between V2X object data received from a second wireless communication device and sensor object data from an onboard sensor. The wireless communication device may establish a match between a V2X object and a sensor object in accordance with the deviation being below a threshold for at least a first time period. The wireless communication device may detect a loss of sensor visibility to the sensor object and may maintain the match between the V2X object and the sensor object for at least a second time period after the loss of sensor visibility to the sensor object. The V2X object data may be safety-qualified based on the maintained match between the V2X object and the sensor object.

### CROSS REFERENCE

The present Application for Patent claims priority to U.S. Provisional Ser. No. 63/745,329 by HARAN et al., entitled “METHOD AND APPARATUS FOR USING UNQUALIFIIED V2X DATA IN A SAFETY SYSTEM” and filed Jan. 15, 2025, which is assigned to the assignee hereof and is expressly incorporated by reference in its entirety herein.

### TECHNICAL FIELD

This disclosure relates generally to wireless communication, and more specifically to systems, devices, methods, and techniques associated with using vehicle-to-everything (V2X) data in a safety system, and in particular using Quality Managed (QM) V2X data in an Automotive Safety Integrity Level (ASIL) Advanced Driver-Assistance System (ADAS) for enhanced protection and braking activation.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN) or some other wireless network) that supports communication between wireless communication devices (e.g., vehicle-to-everything (V2X) devices, network entities, base stations, client devices, one or more user equipments (UEs), and others). Such devices may communicate with one another using a variety of protocols (e.g., direct communication protocols, which may be in accordance with various Institute of Electrical and Electronics Engineers (IEEE) communication standards (IEEE802.11p or IEEE802.11db), or radio access technologies (RATs)), including those of cellular-based systems such as fourth generation (4G) systems (e.g., Long Term Evolution (LTE) systems, such as LTE-VTX), fifth generation (5G) systems (e.g., 5G New Radio (5G-NR) systems, such as NR-V2X), and sixth generation (6G) systems. A wireless communication network may support communication by implementing system resources (such as frequency resources, time resources, spatial resources) in accordance with a wireless communication protocol.

In some wireless communication systems, Vehicle-to-Everything (V2X) technology may have the potential to improve road safety by detecting risks posed by hidden road users. The impact of V2X may grow significantly when V2X is integrated into vehicle braking systems. However, to achieve this, V2X may be required to attain Automotive Safety Integrity Level (ASIL) certification, which is often a requirement for vehicular electronics whose failure could endanger lives. However, achieving ASIL certification for V2X remains a challenge. Until then, a large number of V2X devices may operate under QM (Quality Management) standards. Additionally, or alternatively, low-cost V2X devices, such as those used in two-wheelers, may remain under QM standards due to cost and complexity constraints.

FIG. 1A illustrates an ADAS 100 utilizing post-sensing ASIL V2X fusion. In this approach, V2X data may be integrated with other sensors after the perception phase is complete. Conversely, joint-sensing integrates V2X data directly into the perception process to increase the probability of perception. The system's sensors 112, including cameras, radars, and potentially light detection and ranging (LiDAR) sensors, may be used by the sense unit 116, which may identify objects after running the perception algorithm. These may then be merged by the fusion unit 118 with V2X data from the V2X unit 114. The fused data may then be passed to the plan unit 120 for decision-making.

FIG. 1B illustrates an ADAS 110 utilizing joint-sensing, where the dedicated fusion unit 118 is absent. Instead, its functionality may be embedded into the perception algorithm inside the sense unit 116′ using V2X.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a first wireless communication device is described. The method may include receiving vehicle-to-everything (V2X) object data, establishing a match between a V2X object and a sensor object in accordance with a deviation between the V2X object data and sensor object data being below a threshold for at least a first time period, and maintaining the match between the V2X object and the sensor object for at least a second time period responsive to a moderate deviation between the V2X object data and the sensor object data, where the V2X object data is safety-qualified based on the maintained match between the V2X object and the sensor object.

A first wireless communication device for wireless communication is described. The first wireless communication device may include a transceiver and a processing system that includes processor circuitry and memory circuitry that stores code. The processing system may be configured to receive V2X object data via the transceiver, establish a match between a V2X object and a sensor object in accordance with a deviation between the V2X object data and sensor object data being below a threshold for at least a first time period, and maintain the match between the V2X object and the sensor object for at least a second time period responsive to a moderate deviation between the V2X object data and the sensor object data, where the V2X object data is safety-qualified based on the maintained match between the V2X object and the sensor object.

Another first wireless communication device for wireless communication is described. The first wireless communication device may include means for calculating a deviation between V2X object data received from a second wireless communication device and sensor object data from an onboard sensor, means for establishing a match between a V2X object and a sensor object in accordance with the deviation being below a threshold for at least a first time period, and means for maintaining the match between the V2X object and the sensor object for at least a second time period responsive to a moderate deviation between the V2X object data and the sensor object data, where the V2X object data is safety-qualified based on the maintained match between the V2X object and the sensor object.

A non-transitory computer-readable medium storing code for wireless communication is described. The code may include instructions executable by one or more processors to calculate a deviation between V2X object data received from a second wireless communication device and sensor object data from an onboard sensor, establish a match between a V2X object and a sensor object in accordance with the deviation being below a threshold for at least a first time period, and maintain the match between the V2X object and the sensor object for at least a second time period responsive to a moderate deviation between the V2X object data and the sensor object data, where the V2X object data is safety-qualified based on the maintained match between the V2X object and the sensor object.

In some examples of the method, first wireless communication devices, and non-transitory computer-readable medium described herein, the V2X object data remains detectable by the first wireless communication device after a loss of sensor visibility to the sensor object.

Some examples of the method, first wireless communication devices, and non-transitory computer-readable medium described herein may further include operations, features, means, or instructions for detecting a loss of sensor visibility to the sensor object and using the V2X object data for one or more operations of an Advance Driver-Assistance System (ADAS) after the loss of sensor visibility to the sensor object in accordance with the maintained match.

In some examples of the method, first wireless communication devices, and non-transitory computer-readable medium described herein, the one or more operations of the ADAS include perception of one or more objects, braking activation, or both.

Some examples of the method, first wireless communication devices, and non-transitory computer-readable medium described herein may further include operations, features, means, or instructions for monitoring a stability of the V2X object data from the second wireless communication device during the second time period and discontinuing use of the V2X object data in accordance with a stability of the V2X object data failing to satisfy a threshold stability.

Some examples of the method, first wireless communication devices, and non-transitory computer-readable medium described herein may further include operations, features, means, or instructions for injecting one or more faults into the V2X object data and inputting the V2X object data into a perception algorithm after injecting the one or more faults, where monitoring the stability of the second V2X object data may be based on one or more outputs of the perception algorithm.

In some examples of the method, first wireless communication devices, and non-transitory computer-readable medium described herein, the deviation between the V2X object data and the sensor object data may be based on a distance, a lateral separation, a speed, a heading, or a combination thereof.

In some examples of the method, first wireless communication devices, and non-transitory computer-readable medium described herein, the first time period associated with establishing the match between the V2X object and the sensor object may be 2 seconds.

Some examples of the method, first wireless communication devices, and non-transitory computer-readable medium described herein may further include operations, features, means, or instructions for performing an integrity check procedure on the V2X object data to evaluate a legitimacy of the V2X object data, where calculating the deviation between the V2X object data and the sensor object data may be based on performing the integrity check procedure.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1A-1D show examples of an Advanced Driver-Assistance System (ADAS).

FIGS. 2A and 2B show examples of block diagrams that support using vehicle-to-everything (V2X) data in a safety system.

FIGS. 3-7 how examples of flowcharts that supports using V2X data in a safety system.

FIG. 8 shows an example of a system that supports using V2X data in a safety system.

FIG. 9 shows a flowchart illustrating methods that support using V2X data in a safety system.

FIG. 10 shows a block diagram of an example wireless communication device that supports using V2X data in a safety system.

Like reference numbers and designations in the various drawings indicate like elements.

### DETAILED DESCRIPTION

In accordance with examples described herein, to enable the use of V2X data from these devices in an Advanced Driver-Assistance System (ADAS) (e.g., an ADAS braking activation), a system may be proposed that incorporates safety mechanisms for integrating QM V2X into ADAS, supporting both post-sensing and joint-sensing approaches. For example, a method and apparatus for using unqualified V2X data in a safety system may be presented.

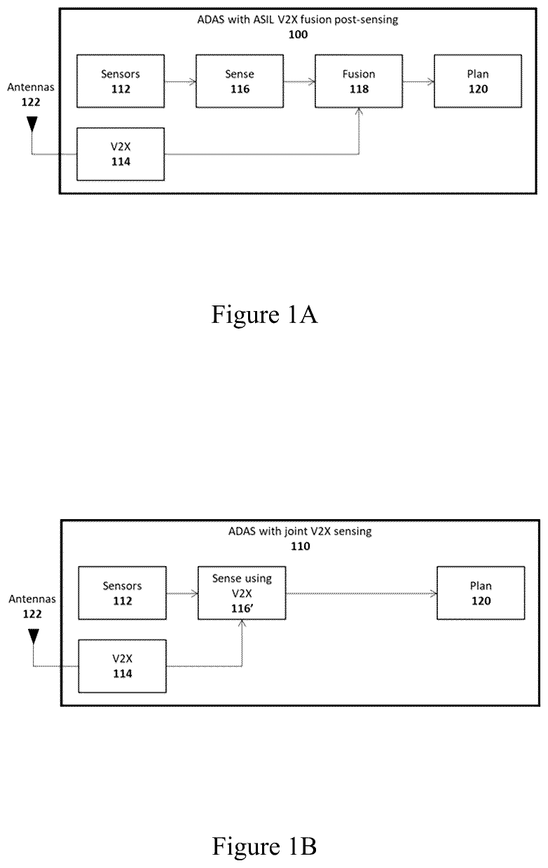

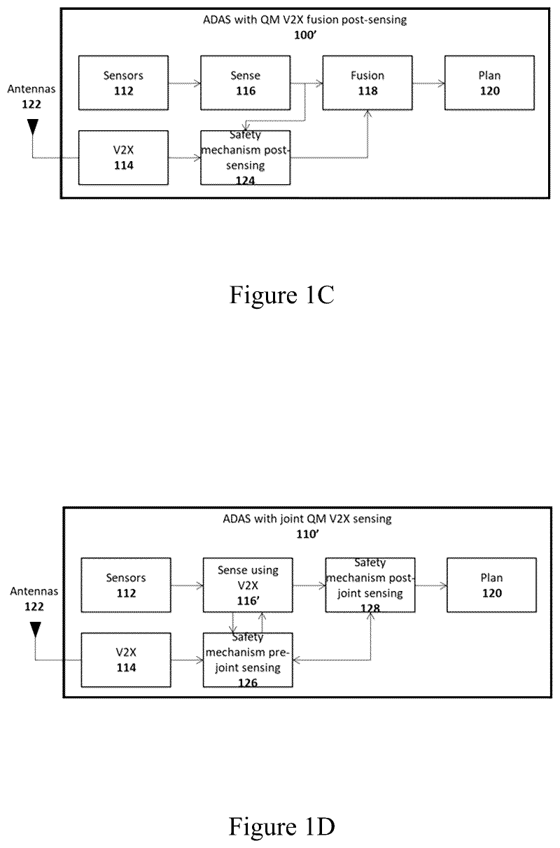

FIG. 1C illustrates an ADAS 100′ for post-sensing QM V2X fusion. A V2X safety mechanism 124 for post-sensing fusion may be added between the V2X unit 114 and the fusion unit 118 to ensure the safe utilization of unqualified V2X data (e.g., V2X object data is not ASIL certified data). This V2X safety mechanism 124 may use the output of the sense unit 116 to corroborate the V2X, thereby achieving high fault detection coverage.

FIG. 1D illustrates an ADAS 110′ for early QM V2X fusion. The V2X safety mechanism 124′ may be enhanced to support joint-sensing operation. The V2X safety mechanism 124′ may operate before the perception unit. Another V2X safety mechanism 128 may be implemented post-joint-sensing unit for validating the output of the sense unit 116′ using V2X before it is utilized by the plan unit 120.

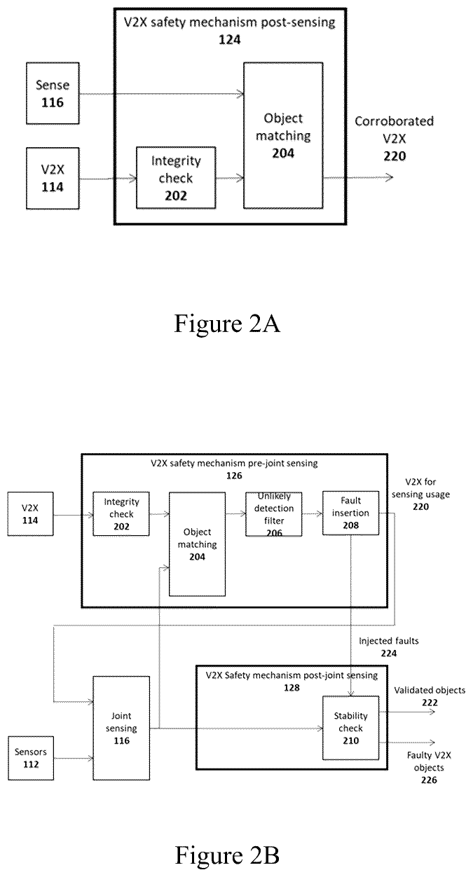

FIG. 2A illustrates a block diagram that shows a V2X safety mechanism for post-sensing fusion. The data from V2X unit 114 may first pass through an integrity check unit 202, which identifies potential faults such as corrupted frame structure, out-of-range values, or inconsistencies, such as path history mismatch with historical object locations. Once deemed legitimate, the V2X data may be sent to the object matching unit 204, where it is compared with sensor data (e.g., from the sense unit 116). This comparison may attempt to pair a V2X object with the corresponding object detected by a sensor. If their locations and movements align over a first time period, e.g., 2 seconds, the two may be considered matched, and the V2X data may be deemed safe for use. However, if the object is matched and the V2X data deviates significantly from the sensor data, the objects may be flagged as unmatched, allowing for quick identification of potential V2X faults. The corroborated V2X data 220, having undergone fault detection targeting detection of >90% or >99%, based on the original equipment manufacturer (OEM) usage, of all potential V2X faults, may then be fused. At this point, the unique attributes of V2X data, such as heading and acceleration, may enhance the sensor data, improving object movement prediction accuracy.

FIG. 2B illustrates a block diagram that shows a V2X safety mechanism for joint-sensing, expanding on the mechanism for post-sensing fusion depicted in FIG. 2A. The integrity check unit 202 and object matching unit 204 may remain unchanged. The output from unit 204 may be directed to the unlikely detection filter 206, which processes unmatched V2X objects. Exceptions may be made for objects undergoing a matching process where a pair has been identified, but the time period (e.g., a threshold time period, for example a first time period) to declare a match has not yet elapsed. Unmatched V2X objects may carry higher uncertainty regarding their integrity; therefore, those objects that could benefit the perception algorithm may be forwarded to it. The unlikely detection filter may remove objects considered improbable to be detected, such as those outside the sensors'range or field of view, or those that should have been detected by the sensors due to being closer than other detected objects.

The fault insertion unit 208 may challenge the reaction of the perception algorithm to V2X data. The algorithm may be expected to treat V2X data as supplementary rather than primary information. By introducing faults to V2X data, the algorithm's output may remain stable, confirming that the detected objects are primarily identified by other sensors, with V2X data enhancing detection probability. Periodically, the fault insertion unit may prevent any unmatched and unstable V2X data from being used, testing whether the perception algorithm's detections are impacted by the presence or absence of V2X data. The output of the fault insertion unit, labeled as V2X data 220 for sensing usage, may be forwarded to the sense unit 116 running the perception algorithm.

The output from the sense unit 116 (e.g., a joint sensing unit) may be assessed by the stability check unit 210, the sole element of the V2X safety mechanism 128 operating post-perception. The stability check unit 210 may ensure that the perceived objects'locations remain consistent, even when V2X fault is introduced or unmatched and unstable V2X data is periodically withheld. The stability check unit 210 may use the injected faults input 224 as provided by the fault insertion unit 208. The output of the stability check unit, termed sensing objects for plan 222, may be sent to plan unit 120.

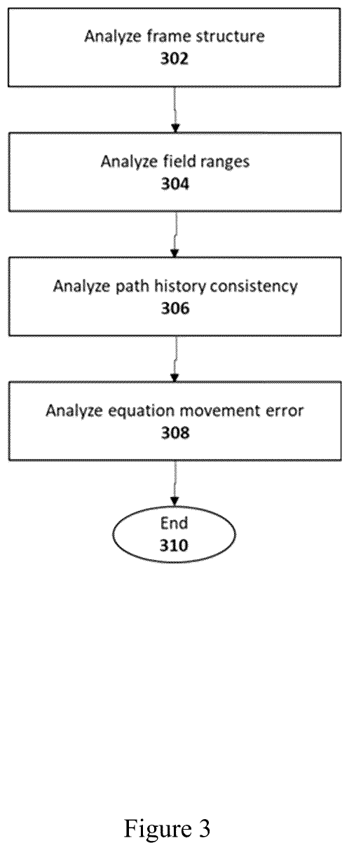

FIG. 3 illustrates a flowchart of a V2X integrity check. The flowchart may detail the operation of unit 202 integrity check. The process may begin with step 302, where the frame structure may be analyzed. This may involve verifying that the frame length is as expected, all mandatory fields are present with correct lengths, and a validation mechanism such as a cyclic redundancy check (CRC) is included and accurate. Next, in step 304, the ranges of values may be checked to ensure they are reasonable. For instance, vehicle speed and acceleration should fall within expected limits. In step 306, path history consistency may be evaluated. The received path history may be evaluated for alignment with earlier path history messages or the object's stored historical locations. In other words, the evaluation may determine whether the reported path history, which outlines where the road user has been, deviates from previously reported or logged historical locations.

Step 308 involves analyzing the equation movement error. The V2X message may provide data that can be validated without additional inputs. For example, the current speed may be compared with previous speed and acceleration values, and the current heading may be matched against the previous heading and yaw rate values. Similarly, the current location may be estimated based on the previous location, speed, acceleration, heading, and yaw rate. Any significant deviation may indicate a fault in one or more data fields. Finally, in step 310, all messages failing to pass the plausibility checks may be discarded, concluding the process.

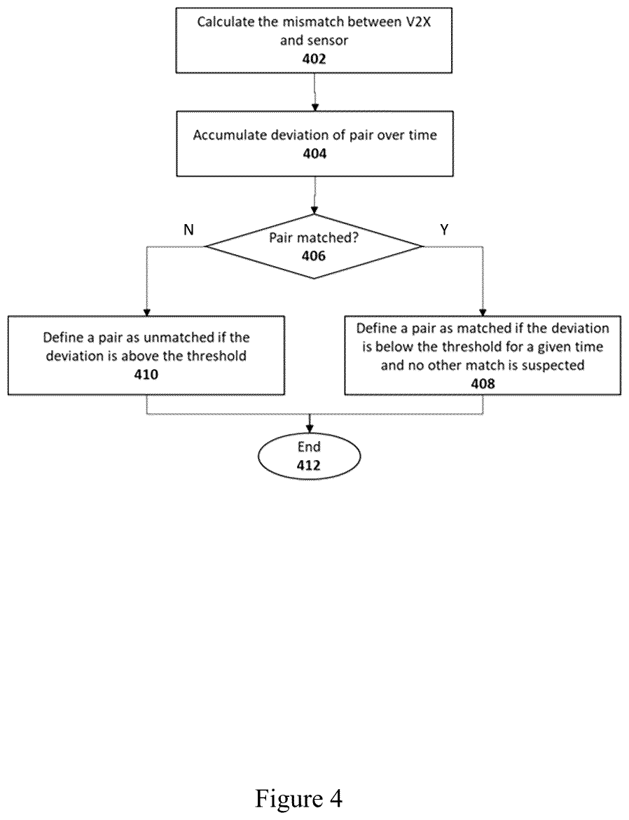

FIG. 4 illustrates a flowchart of V2X and sensor object matching. The flowchart may detail the operation of object matching unit 204. Step 402 may be a step in an initial matching process, e.g., where a V2X and a sensor object have not previously been matched. Additionally or alternatively, step 402 may be a step in a process of determining whether a previous match between a V2X object and a sensor object is to be maintained. The process may begin at step 402, where the deviation between a V2X object and a sensor object may be calculated. This deviation may add various criteria, including distance, lateral separation, speed, and heading, while allowing for permissible deviations. For example, distance differences up to the greater of 10% of the distance or 4 meters, lateral separation differences up to 1.8 meters, speed differences up to 2 meters/second, and heading differences up to 8 degrees may be ignored. In another example of a deviation, a V2X object may be detected and a sensor object may not be detected (e.g., either initially not detected or not detected after loss of sensor visibility to the sensor object), and hence a deviation between the detected V2X object and the undetected sensor object may be calculated accordingly. In step 404, the deviation calculated in step 402 may be accumulated over time. A decay factor may be applied to prevent temporary mismatches from having a lasting impact. In one example where an initial match was previously determined, a simple decay factor could include a threshold time, e.g., a second time period, during which a match is maintained even if there is a (temporary) deviation between a V2X object and a sensor object, where such deviation would otherwise have resulted in the match not being maintained. More elaborate decay factors may additionally or alternatively be applied.

Next, in step 406, a check may determine whether the V2X and sensor objects are classified as matched. If not, step 408 may evaluate whether the pair can be defined as matched if the accumulated deviation is below threshold for a specific duration or a first time period (e.g., 2 seconds). Additionally, the pair may be exclusive, meaning the V2X and sensor objects cannot simultaneously be part of matches with other objects-no other V2X object to sensor object or other sensor object to V2X object pairing should exhibit low deviation. If these conditions are met, the process may conclude at step 412. If the step 406 check determines that the pair is unmatched, the operation may proceed to step 410. If the deviation exceeds a defined threshold, the pair may be classified as unmatched, as shown in step 410. After an initial match was previously determined, where, for example, step 406 determines whether a match is to be maintained or not, a significant deviation associated with step 404 may result in immediate unmatching, while a moderate deviation may lead to unmatching over time, e.g., the passing of a threshold time, such as a second time period, ensuring confidence that the V2X and sensor objects have diverged. As such, once an initial match is established, the match can be maintained for at least a second time period, e.g., after loss of sensor visibility to the sensor object. If the deviation continues for longer than the second time period, the previously matched V2X and sensor objects may then be determined as no longer matched.

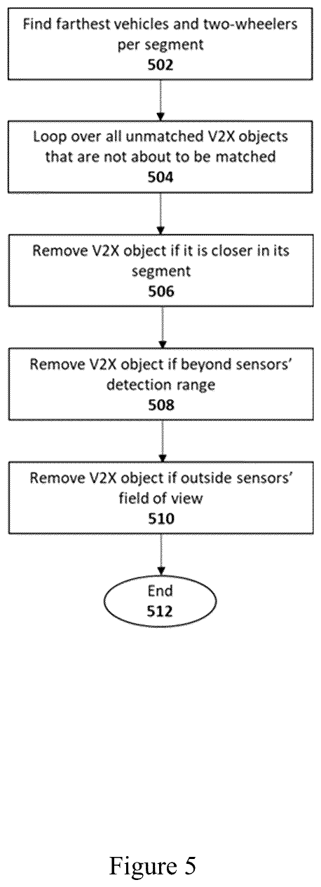

FIG. 5 illustrates a flowchart of filtering V2X objects that are unlikely to be detected and/or matched (e.g., filtering objects before an initial match, as described in FIG. 4). The flowchart may detail the operation of unlikely detection filter 206. The process may begin at step 502, where the farthest vehicles and two-wheelers may be identified for each segment within the field of view of the self-vehicle. The field of view may be divided into segments (for example, 16 segments, each spanning 9 degrees if the field of view is ±72 degrees). A loop may iterate over all vehicles and two-wheelers detected by the sensors, mapping them to their respective segments. If no other vehicle or two-wheeler in a segment is farther away, the farthest object in that segment may be set to the iterated vehicle or two-wheeler. The operation may then proceed to step 504, where a loop may be initiated to evaluate objects detected by V2X, if unmatched, except for those expected to be matched. Objects expected to be matched may refer to objects for which a pair has been identified (e.g., the deviation is minimal), but the time period (e.g., a threshold time period) to declare a match has not yet elapsed.

In step 506, if a V2X object is closer than the farthest object identified in step 502 in the respective segment, it may be discarded as unplausible, as it should have been detected by the sensors. Next, in step 508, the distance of the V2X object may be compared with the maximum detection range of the sensors. If the V2X object is beyond the sensor's range, it may be dropped. Sensor detection ranges may vary due to conditions like nighttime or bad weather. For example, while the range may be 90 meters under ideal conditions, it might be reduced to 60 meters at night. In step 510, any V2X object outside the sensors'field of view may be removed. For instance, an object at 74 degrees may be discarded if the field of view is ±72 degrees. Finally, the process may conclude at step 512.

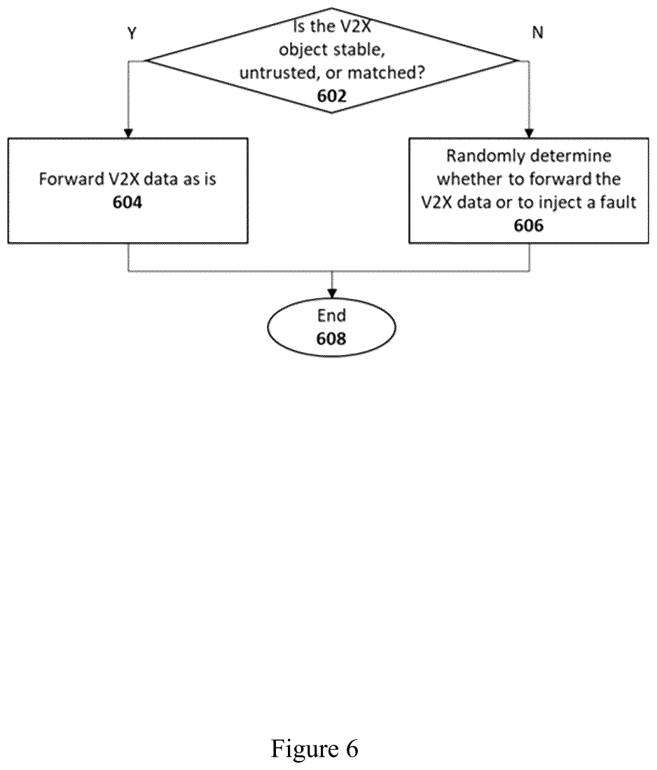

FIG. 6 illustrates a flowchart of V2X fault insertion before feeding perception. The flowchart may detail the operation of fault insertion unit 208. The process may begin at step 602, where it may be determined whether the object is classified as either matched or stable unmatched. A stable unmatched object may be defined as one whose use does not compromise the stability of the perception algorithm operation. If this condition is met, the operation may continue from step 604 and the V2X data may be forwarded to the sense unit. The operation may then conclude at step 608.

If, in step 602, the object is found to be unmatched and its stability is unproven, the operation may proceed to step 606. During each activation of the perception algorithm, different V2X outputs for the unmatched and unproven stability object may be randomly applied. One option selected randomly may be not to forward the V2X data. In the second random option, V2X data may be forwarded with injected fault biasing the location by a random value. Once completed, the operation may end at step 608.

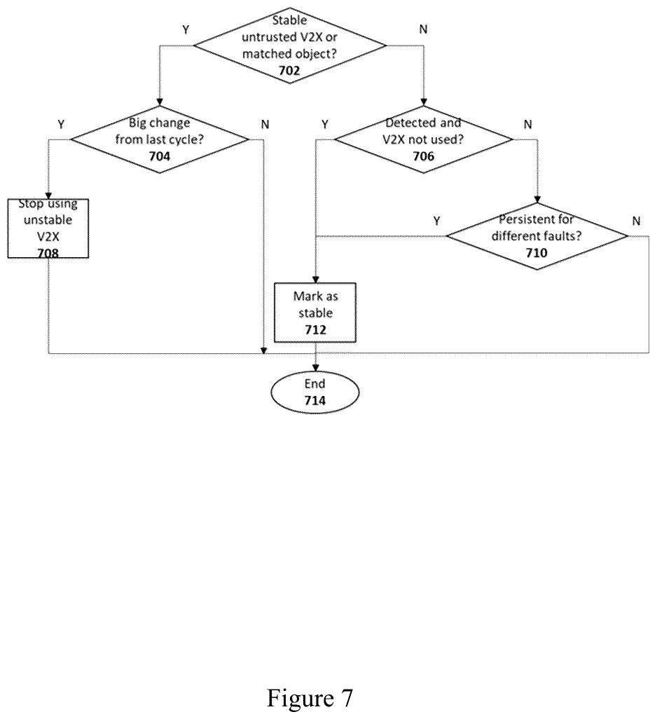

FIG. 7 illustrates a flowchart of a perception output stability check. The flowchart may detail the operation of stability check unit 210. The process may begin at step 702, where it may be determined whether the object is classified as matched or as stable unmatched. If this condition is met, the process may proceed to step 704, where it checks if the detection of the object has undergone a significant shift since the last perception activation (e.g., a stability of the match is monitored during a second time period). If a major shift is detected (e.g., if a stability of the match fails to satisfy a threshold stability), the process may move to step 708, where the use of unstable V2X data may be discontinued to mitigate risk. The operation may then conclude at step 714. If no significant change is detected in step 704, no further action may be taken, and the process may end at step 714.

If step 702 identifies the object as untrusted and unstable, the operation may proceed to step 706. Here, it may check if the object was detected by sensors without relying on V2X data after it was periodically omitted during the perception process in step 606 of the fault insertion unit 208. If the object is sensor-detected, the process may move to step 712, where the object may be marked as stable, and the operation may conclude at step 714. If the perception algorithm used V2X data in step 706, the process may continue to step 710 to determine if the object's location remains consistent despite the fault injection. This may involve verifying that the location shifts only minimally (e.g., within a threshold amount) when V2X data was deliberately altered. If the object's location is found to be stable under these conditions, the process may advance to step 712, where the object may be marked as stable. If not, the object may remain unstable, and the operation may end at step 714.

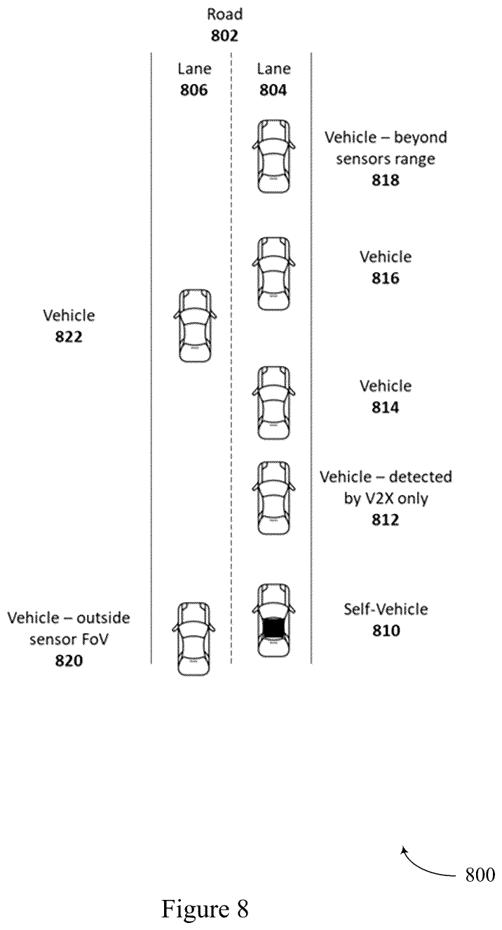

FIG. 8 illustrates a system 800 that shows an example of using unqualified V2X data (e.g., V2X object data is not ASIL certified) in an ADAS system. The self-vehicle 810 may be driving in lane 804 of road 802, while vehicles in lane 806 are positioned to its left. The following vehicle in the driven lane, vehicle 812, may be detected by V2X but may not be detected by the self-vehicle's sensors. Since it is deemed implausible, the V2X data may be discarded and not used in perception. Vehicle 814, detected by the sensors, may be matched with the corresponding V2X data based on similarities in location, speed, and other movement properties.

Farther away, vehicle 816 may not be detected by the sensors (e.g., vehicle 816 may be blocked from the sensors or may have lost line of sight with the sensors despite being within a sensor range) but may be detected by V2X. Initially classified as unmatched and unstable (e.g., due to a loss of sensor visibility to the vehicle 816 after a first time period when the V2X data and sensor data are matched), its V2X data may be fed into the perception algorithm. In many instances, this may not suffice for the perception algorithm to detect the vehicle 816, but in some cases, the V2X data alone may suffice in the absence of sensor data. If the detected location of the vehicle 816 indicated by the V2X data remains stable after fault insertion, the vehicle 816 may be reclassified as unmatched stable and subsequently as matched after 2 seconds (e.g., and may be maintained as matched during at least a second time period). Vehicle 818 may be beyond the sensor detection range and its V2X data may therefore not be forwarded to the perception algorithm. Similarly, vehicle 820, positioned behind the self-vehicle in the left lane and outside the field of view (e.g., since the self-vehicle in this example has a single camera) may also be excluded from the perception algorithm. Lastly, vehicle 822, traveling in the left lane, may be matched between V2X and sensor data. Its position in a different segment from the vehicles in the self-vehicle's lane may support this alignment.

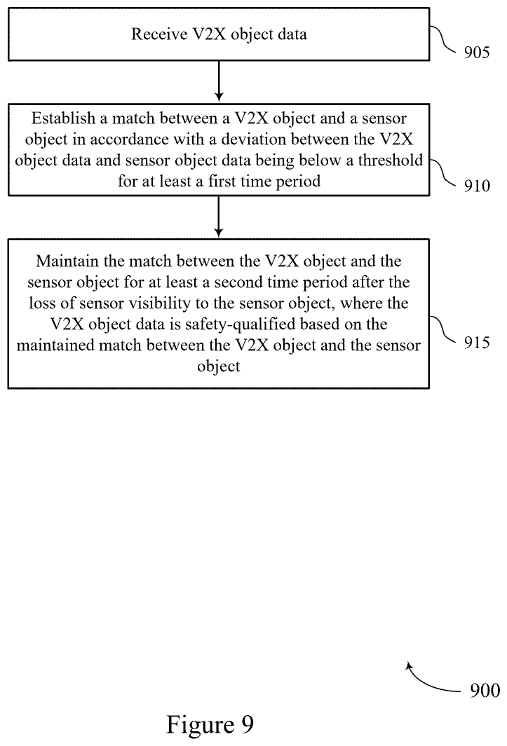

FIG. 9 shows a flowchart illustrating a method 900 that supports using V2X data in a safety system.

At 905, the method may include calculating a deviation between V2X object data received from a second wireless communication device and sensor object data from an onboard sensor.

At 910, the method may include establishing a match between a V2X object and a sensor object in accordance with the deviation being below a threshold for at least a first time period.

At 915, the method may include maintaining the match between the V2X object and the sensor object for at least a second time period after the loss of sensor visibility to the sensor object, where the V2X object data is safety-qualified based on the maintained match between the V2X object and the sensor object.

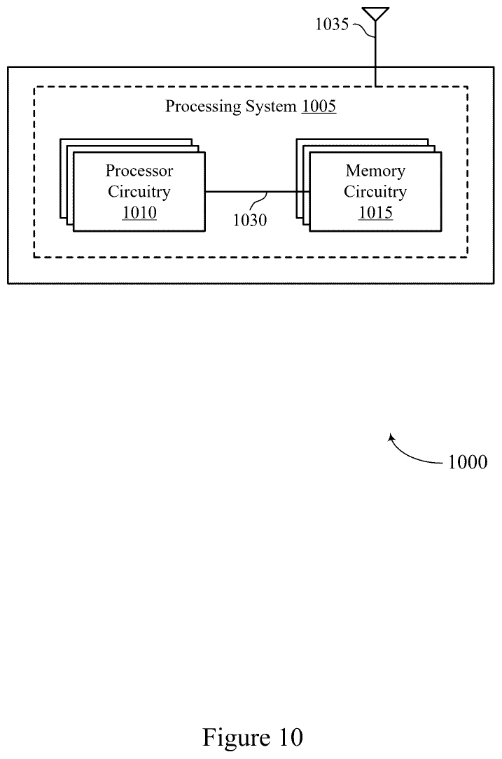

FIG. 10 shows a block diagram of an example wireless communication device 1000 that supports using V2X data in a safety system. A wireless communication device 1000 may be capable of transmitting and receiving wireless communications in the form of, for example, wireless packets. For example, a wireless communication device 1000 may be configurable or configured to transmit and receive signals and communications conforming to one or more 3GPP specifications including those for 5G NR or 6G, among others. Additionally, or alternatively, a wireless communication device 1000 may be configurable or configured to transmit and receive signals and communications conforming to one or more of the IEEE 802.11 family of wireless communication protocol standards, among others. Additionally, or alternatively, a wireless communication device 1000 may be configurable or configured to transmit and receive V2X signals and communications. In some examples, the wireless communication device 1000 may be included in a vehicle.

In some examples, the wireless communication device 1000 may be configured or configurable to perform the method 900.

A wireless communication device 1000 may include one or more chips, system on chips (SoCs), chipsets, packages, components or devices that individually or collectively constitute or include a processing system 1005. A processing system 1005 may interface with other components of a wireless communication device 1000 and may generally process information (such as inputs or signals) received from such other components and output information (such as outputs or signals) to such other components. As shown in FIG. 10, the wireless communication device 1000 includes a processing system 1005 that includes processor circuitry 1010 (such as one or more processor circuits or circuitry, processing circuitry, a processor) and memory circuitry 1015 (such as one or more memory circuits or circuitry, a memory).

Processor circuitry 1010 may be collectively configured to perform Physical (PHY) layer operations and Medium Access Control (MAC) layer operations, and, in some instances, upper layer operations, associated with transmitting and receiving wireless communications. Processor circuitry 1010 may be implemented in the form of one or multiple processors, microprocessors, application processors, host processors, processing units (such as central processing units (CPUs), graphics processing units (GPUs), neural processing units (NPUs) (also referred to as neural network processors or deep learning processors (DLPs)), data processing units (DPUs), associative processing units (APUs), tensor processing units (TPUs), language processing units (LPU), vision processing units (VPUs), quantum processing units (QPUs) or digital signal processors (DSPs)), processing blocks, application-specific integrated circuits (ASIC), programmable logic devices (PLDs), or other discrete gate or transistor logic or circuitry (each of which may be generally referred to herein individually as “a processor” or “processor circuitry 1010”). One or more processors of processor circuitry 1010 may be individually or collectively configurable or configured to perform various functions or operations described herein. A group of processors of processor circuitry 1010 collectively configurable or configured to perform a set of operations may include a first processor configurable or configured to perform a first operation of the set and a second processor configurable or configured to perform a second, different operation of the set. In some other examples, each of a group of processors of processor circuitry 1010 may be configurable or configured to perform a same set of operations.

Memory circuitry 1015 may be collectively configured for storing, accessing or retrieving stored information at the request of processor circuitry 1010, including operations associated with transmitting and receiving wireless communications. Generally, components of memory circuitry 1015 may be coupled with components of processor circuitry 1010 and individually or collectively store processor-executable code that, when executed by the processor circuitry 1010 (such as directly, indirectly, without pre-processing, after pre-processing), such as by one or more processors, may configure or enable the processor circuitry 1010, such as one or more of the same or different processors, to perform various operations described herein. However, in some examples, some of the processor circuitry 1010 may be preconfigured to perform various operations described herein without requiring configuration or enablement by code stored in the memory circuitry 1015.

Memory circuitry 1015 may be implemented in the form of one or more memory devices, memory components, memory blocks, memory elements or other discrete gate or transistor logic or circuitry. Memory circuitry 1015 may include tangible storage media including non-volatile memory, such as read-only memory (ROM), or volatile memory, such as random-access memory (RAM) (such as static RAM (SRAM), dynamic RAM (DRAM), or synchronous DRAM (SDRAM) such as low power double data rate (LPDDR) memory, among other examples, each of which may be generally referred to herein individually as “a memory” or “memory circuitry 1015”) In some examples, a processing system 1005, and processor circuitry 1010 within it, may also be coupled with memory circuitry outside of or distinct from the processing system 1005. For example, such additional memory circuitry may include a non-volatile memory storage device such as a solid state drive (SSD), a hard disk drive (HDD), or removable storage media. In some other examples, additional memory circuitry also may include volatile memory such as SRAM, DRAM, SDRAM, LPDDR memory, among other examples.

Processor circuitry 1010 may be coupled directly or indirectly with memory circuitry 1015 via an interface 1030 (such as one or more interfaces). An interface 1030 may include any suitable quantities or types of interconnecting buses, bridges or circuitry depending on the specific applications and overall design constraints. In some examples, some or all of the processor circuitry 1010 may be interconnected together within one chip, SoC, or package. Such a chip, SoC or package also may include memory circuitry 1015 integrated within it. In some other examples, a processing system 1005 may include any suitable combination of two or more distinct chips, SoCs, chipsets, packages, components or devices, each of which may include respective processor circuitry 1010 or memory circuitry 1015, or both.

A wireless communication device 1000 may also include any additional circuitry or components for processor circuitry 1010 to operate to perform the functions and processes described herein related to wireless communication. For example, as is also shown in FIG. 10, a processing system 1005 may be directly or indirectly coupled with one or more antennas 1035, which may be in the form of one or more individual antenna elements, antenna arrays, or antenna panels, among other examples. The one or more antennas 1035 may include or be coupled with antenna circuitry, one or more antenna components, or one or more antenna modules, among other examples. Additionally, in some examples, a processing system 1005, including processor circuitry 1010, may include, be coupled with, or be connected to one or more modem circuits or circuitry (not specifically shown), such as in the form of one or more modem chips (also referred to herein simply as “modems”), each including processor circuitry configured for performing modulation or demodulation of wireless communication signals, among other functions associated with PHY layer operations. In some examples, a wireless communication device 1000 may alternatively include distinct modem circuitry, such as one or more modems, separate from but coupled with or connected to a processing system 1005, such as including processor circuitry 1010.

In some examples, modem circuitry, whether implemented internal to or external to a processing system 1005, may also include, be coupled with, or be connected to one or more radio frequency (RF) and analog circuits or circuitry (not specifically shown). In some examples in which a processing system 1005 includes modem circuitry, the processing system 1005 may include at least some of the RF and analog circuitry. In some other examples, most or all of the RF and analog circuitry may be separate from but coupled directly or indirectly with or connected to a processing system 1005, such as to the modem circuitry. The RF and analog circuitry may include RF chains or transceiver circuitry (such as transceivers), which may include one or more filters, mixers, oscillators, amplifiers such as power amplifiers (PAs) or low-noise amplifiers (LNAs), analog-to-digital converters (ADCs), digital-to-analog converters (DACs), power trackers, or other components that process signals including converting them between analog (such as for transmission or reception via an air interface) and digital (such as for processing by the processor circuitry 1010) domains. The RF and analogy circuitry may, in turn, be coupled with or connected to antenna modules that connect to the physical antennas or antenna arrays.

In some examples, a wireless communication device 1000 may also include at least one other external network interface (not shown) that enables the processing system 1005 to communicate with another network (such as a core network, a backhaul network) to gain access to external networks including the Internet. For example, a wireless communication device 1000 may include multiple external network interfaces including one or more wired or wireless network interfaces (such as to support a backhaul link). A wireless communication device 1000 may also include one or more external network interfaces, such as a wireless local area network (WLAN) interface, to provide a backhaul.

Implementation examples are described in the following numbered clauses:
Aspect 1: A method for wireless communication by a first wireless communication device, comprising: receiving V2X object data; establishing a match between a V2X object and a sensor object in accordance with a deviation between the V2X object data and sensor object data being below a threshold for at least a first time period; and maintaining the match between the V2X object and the sensor object for at least a second time period responsive to a moderate deviation between the V2X object data and the sensor object data, wherein the V2X object data is safety-qualified based at least in part on the maintained match between the V2X object and the sensor object.
Aspect 2: The method of aspect 1, wherein the V2X object data remains detectable by the first wireless communication device after a loss of sensor visibility to the sensor object.
Aspect 3: The method of any of aspects 1 through 2, further comprising: detecting a loss of sensor visibility to the sensor object; and using the V2X object data for one or more operations of an ADAS after the loss of sensor visibility to the sensor object in accordance with the maintained match.
Aspect 4: The method of aspect 3, wherein the one or more operations of the ADAS comprise perception of one or more objects, braking activation, or both.
Aspect 5: The method of any of aspects 1 through 4, further comprising: monitoring a stability of the V2X object data from the second wireless communication device during the second time period; and discontinuing use of the V2X object data in accordance with a stability of the V2X object data failing to satisfy a threshold stability.
Aspect 6: The method of aspect 5, further comprising: injecting one or more faults into the V2X object data; and inputting the V2X object data into a perception algorithm after injecting the one or more faults, wherein monitoring the stability of the second V2X object data is based at least in part on one or more outputs of the perception algorithm.
Aspect 7: The method of any of aspects 1 through 6, wherein the deviation between the V2X object data and the sensor object data is based at least in part on a distance, a lateral separation, a speed, a heading, or a combination thereof.
Aspect 8: The method of any of aspects 1 through 7, wherein the first time period associated with establishing the match between the V2X object and the sensor object is 2 seconds.
Aspect 9: The method of any of aspects 1 through 8, further comprising: performing an integrity check procedure on the V2X object data to evaluate a legitimacy of the V2X object data, wherein calculating the deviation between the V2X object data and the sensor object data is based at least in part on performing the integrity check procedure.
Aspect 10: A first wireless communication device for wireless communication, comprising a transceiver and a processing system that includes processor circuitry and memory circuitry that stores code, the processing system configured to perform a method of any of aspects 1 through 9.
Aspect 11: A first wireless communication device for wireless communication, comprising at least one means for performing a method of any of aspects 1 through 9.
Aspect 12: A non-transitory computer-readable medium storing code for wireless communication, the code comprising instructions executable by one or more processors to perform a method of any of aspects 1 through 9.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, investigating, looking up, inferring, ascertaining, measuring, resolving, selecting, obtaining, choosing, identifying, interpreting, demodulating, decoding, reading, establishing, forming, or generating, among other examples. In some examples, determining can involve a processing system performing some type of calculating, computing, deriving, estimating, inferring, ascertaining, resolving, predicting, or other processing to obtain one or more numerical values, sets, elements, or other information or results. In some examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some examples, determining can involve a processing system identifying, interpreting, demodulating, decoding, detecting, reading, or otherwise obtaining some type of value, set, element, or other information or result signaled in, for example, a received wireless signal. In some examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the terms “has,” “have,” “having,” “comprise,” “comprising,” “include” and “including,” and derivatives thereof or similar terms are intended to be open-ended terms that do not limit an element that they modify (for example, an element “having” a also may have b).

As used herein, the phrase “based on” is equivalent to “based at least in part on” and indicates a non-limiting relationship between elements “a” and “b.” In some aspects, a′ (which may be a variation or example of a) may be responsive to or in response to b′ (which may be a variation or example of b), such as if condition c is met. In some other aspects, a″ (which may be a variation or example of at least one of a or a′) may be associated with b″ (which may be a variation or example of at least one of b or b′). In some further aspects, a′″ (which may be a variation or example of at least one of a or a′ or a″) may be determined (or any of the other actions encompassed by usage of the word “determining” as described above) in accordance with b′″ (which may be a variation or example of at least one of b or b′ or b″). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first wireless communication device, comprising:
a transceiver; and
a processing system that includes processor circuitry and memory circuitry that stores code, the processing system configured to:
receive, via the transceiver, vehicle-to-everything (V2X) object data;
establish a match between a V2X object and a sensor object in accordance with a deviation between the V2X object data and sensor object data being below a threshold for at least a first time period; and
maintain the match between the V2X object and the sensor object for at least a second time period responsive to a moderate deviation between the V2X object data and the sensor object data, wherein the V2X object data is safety-qualified based at least in part on the maintained match between the V2X object and the sensor object.

2. The first wireless communication device of claim 1, wherein the V2X object data is not Automotive Safety Integrity Level (ASIL) certified data.

3. The first wireless communication device of claim 1, wherein the V2X object data remains detectable by the first wireless communication device after a loss of sensor visibility to the sensor object.

4. The first wireless communication device of claim 1, wherein the processing system is further configured to:
detect a loss of sensor visibility to the sensor object; and
use the V2X object data for one or more operations of an Advance Driver-Assistance System (ADAS) after the loss of sensor visibility to the sensor object in accordance with the maintained match.

5. The first wireless communication device of claim 4, wherein the one or more operations of the ADAS comprises braking activation.

6. The first wireless communication device of claim 1, wherein the processing system is further configured to:
inject one or more faults into the V2X object data; and
input the V2X object data into a perception algorithm after injecting the one or more faults.

7. The first wireless communication device of claim 6, wherein the processing system is further configured to:
monitor a stability of the match during the second time period, wherein monitoring the stability of the match is based at least in part on one or more outputs of the perception algorithm; and
discontinue use of the V2X object data in accordance with the stability of the match failing to satisfy a threshold stability.

8. The first wireless communication device of claim 6, wherein, to inject the one or more faults into the V2X object data, the processing system is configured to randomly apply one or more modifications to the V2X object data, the one or more modifications comprising:
not forwarding the V2X object data to the perception algorithm; and
injecting a fault to the V2X object data that biases a location of the V2X object by a random value.

9. The first wireless communication device of claim 1, wherein the deviation between the V2X object data and the sensor object data is based at least in part on a distance, a lateral separation, a speed, a heading, or a combination thereof.

10. The first wireless communication device of claim 1, wherein the processing system is further configured to:
perform, based at least in part on reception of the V2X object data, an integrity check procedure on the V2X object data to evaluate a legitimacy of the V2X object data.

11. A method for wireless communication by a first wireless communication device, comprising:
calculating a deviation between vehicle-to-everything (V2X) object data received from a second wireless communication device and sensor object data from an onboard sensor;
establishing a match between a V2X object and a sensor object in accordance with the deviation being below a threshold for at least a first time period; and
maintaining the match between the V2X object and the sensor object for at least a second time period responsive to a moderate deviation between the V2X object data and the sensor object data, wherein the V2X object data is safety-qualified based at least in part on the maintained match between the V2X object and the sensor object.

12. The method of claim 11, wherein the V2X object data remains detectable by the first wireless communication device after a loss of sensor visibility to the sensor object.

13. The method of claim 11, further comprising:
detecting a loss of sensor visibility to the sensor object; and
using the V2X object data for one or more operations of an Advance Driver-Assistance System (ADAS) after the loss of sensor visibility to the sensor object in accordance with the maintained match.

14. The method of claim 13, wherein the one or more operations of the ADAS comprise braking activation.

15. The method of claim 11, further comprising:
injecting one or more faults into the V2X object data; and
inputting the V2X object data into a perception algorithm after injecting the one or more faults.

16. The method of claim 15, further comprising:
monitoring a stability of the match during the second time period, wherein monitoring the stability of the match is based at least in part on one or more outputs of the perception algorithm; and
discontinuing use of the V2X object data in accordance with the stability of the match failing to satisfy a threshold stability.

17. The method of claim 15, wherein injecting the one or more faults into the V2X object data comprises randomly applying one or more modifications to the V2X object data, the one or more modifications comprising:
not forwarding the V2X object data to the perception algorithm; and
injecting a fault to the V2X object data that biases a location of the V2X object by a random value.

18. The method of claim 11, wherein the deviation between the V2X object data and the sensor object data is based at least in part on a distance, a lateral separation, a speed, a heading, or a combination thereof.

19. The method of claim 11, further comprising:
performing, based at least in part on receiving the V2X object data, an integrity check procedure on the V2X object data to evaluate a legitimacy of the V2X object data.

20. A non-transitory computer-readable medium storing code for wireless communication, the code comprising instructions executable by one or more processors to:
calculate a deviation between vehicle-to-everything (V2X) object data received from a second wireless communication device and sensor object data from an onboard sensor;
establish a match between a V2X object and a sensor object in accordance with the deviation being below a threshold for at least a first time period; and p1 maintain the match between the V2X object and the sensor object for at least a second time period responsive to a moderate deviation between the V2X object data and the sensor object data, wherein the V2X object data is safety-qualified based at least in part on the maintained match between the V2X object and the sensor object.
